(19) United States
(12) Patent Application Publication
(10) Pub. No.: US 2024/0420068 A1
(43) Pub. Date: Dec. 19, 2024

(54) DELIVERY MANAGEMENT SYSTEM

(71) Applicant: TOYOTA JIDOSHA KABUSHIKI KAISHA, Toyota-shi (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinori KIMURA, Ichinomiya-shi (JP); Yoshiaki ABE, Kofu-shi (JP)

(73) Assignee: TOYOTA JIDOSHA KABUSHIKI KAISHA, Toyota-shi (JP)

(21) Appl. No.: 18/734,840

(22) Filed: Jun. 5, 2024

(30) Foreign Application Priority Data
Jun. 16, 2023 (JP) 2023-099302

(51) Int. Cl. G06Q 10/083

(52) U.S. Cl. CPC G06Q 10/083

(57) ABSTRACT

The processing circuit of the delivery management system sets the delivery area based on the current position of the delivery vehicle. The processing circuit notifies the delivery destination located in the delivery area that the package is to be delivered. The processing circuit permits the delivery vehicle to deliver the package to the delivery destination to which the response to the notification of the delivery of the package is received, and does not permit the delivery vehicle to deliver the package to the delivery destination to which the response to the notification has not been received.

### CROSS-REFERENCE TO RELATED APPLICATION

This application claims priority to Japanese Patent Application No. 2023-099302 filed on Jun. 16, 2023, incorporated herein by reference in its entirety.

### BACKGROUND

### 1. Technical Field

The present disclosure relates to a delivery management system that manages a delivery vehicle that delivers a package.

### 2. Description of Related Art

Japanese Unexamined Patent Application Publication No. 2002-56257 (JP 2002-56257 A) discloses a system that calculates a delivery time based on a desired time to receive a package registered in a database, a traveling time of a delivery vehicle, and the like, and notifies a delivery destination for the package of the delivery time.

### SUMMARY

In general, a delivery vehicle sequentially delivers packages to a plurality of delivery destinations. If a road from a first delivery destination to a second delivery destination, among the delivery destinations, is congested, for example, the time to arrive at the second delivery destination is delayed. As a result, there is a discrepancy between the delivery time that the delivery destination is notified of by the system and the actual delivery time. In this case, there is a possibility that a resident of the delivery destination has already gone out when the delivery vehicle arrives at the delivery destination. When the resident of the delivery destination is absent in this manner, it is necessary to visit the delivery destination for delivery again.

In order to address the above issue, an aspect provides a delivery management system that manages a delivery vehicle that delivers a package. The delivery management system includes a processing circuit. The processing circuit is configured to:
set a delivery area in which the delivery vehicle delivers the package based on a current position of the delivery vehicle;
notify a delivery destination of the package located in the delivery area that the package is to be delivered;
allow the delivery vehicle to deliver the package to the delivery destination that has responded to the notification that the package is to be delivered; and
not permit the delivery vehicle to deliver the package to the delivery destination that has not responded to the notification.

The above-described delivery management system has an effect of reducing the burden on a delivery person by suppressing the delivery person delivering a package to a delivery destination at which a resident is absent.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a delivery management system, a delivery vehicle, and a delivery destination according to an embodiment;

FIG. 2 is a diagram showing contents of a database included in the delivery management system shown in FIG. 1;

FIG. 3 is a schematic diagram showing a delivery area set in the delivery management system shown in FIG. 1;

FIG. 4 is a sequence diagram showing a flow of a process for determining whether or not delivery to a delivery destination is permitted; and

FIG. 5 is a flowchart illustrating an aggregation process executed by the delivery management system illustrated in FIG. 1.

### DETAILED DESCRIPTION OF EMBODIMENTS

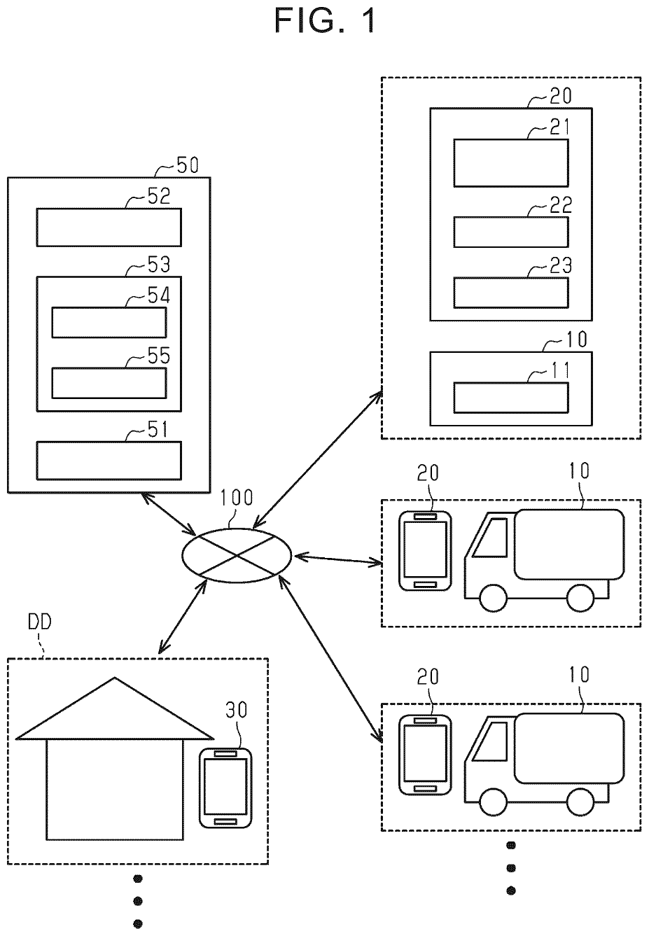

Hereinafter, an embodiment of a delivery management system will be described with reference to FIG. 1 to FIG. 5.

FIG. 1 illustrates a delivery management system 50, a plurality of delivery vehicles 10, and a plurality of delivery destination DD. Here, the “delivery vehicle 10” is a vehicle managed by the delivery management system 50. The “delivery destination” is a place where the package is delivered by the delivery vehicle 10.

### Delivery Destination

The terminal device 30 owned by the address of the delivery destination is configured to be able to communicate with the delivery management system 50 via the communication network 100. Examples of the terminal device 30 include a smartphone, a tablet terminal, and a personal computer.

### Delivery Vehicle

The plurality of delivery vehicles 10 respectively deliver packages to the plurality of delivery destination DD according to a predetermined delivery schedule. Each of the plurality of delivery vehicles 10 has a position information receiver 11 that receives its own position information. The location information received by the position information receiver 11 is transmitted to the delivery management system 50 via the communication network 100. Accordingly, the delivery management system 50 can grasp the current positions of the plurality of delivery vehicles 10.

The delivery vehicle 10 is ridden by a delivery person who delivers the package to the delivery destination DD. The deliverer owns the portable terminal 20. Examples of the mobile terminal 20 include a smartphone and a tablet terminal. The mobile terminal 20 is configured to be able to communicate with the delivery management system 50 via the communication network 100.

The mobile terminal 20 includes a user interface 21, a communication device 22, and a processing circuit 23. The user interface 21 includes a display unit and an operation unit. A message or a thumbnail to be transmitted to the delivery person is displayed on the display unit. The operation unit receives an operation of the delivery person.

The communication device 22 is an interface of the portable terminal 20 for transmitting and receiving information to and from an external communication device via the communication network 100. For example, when receiving the information transmitted by the delivery management system 50, the communication device 22 outputs the information to the processing circuit 23. For example, the communication device 22 transmits the information output by the processing circuit 23 to the delivery management system 50.

An example of the processing circuit 23 is an electronic control unit. The processing circuit 23 comprises CPU and memories. It stores a control program that is executed by CPU. When CPU executes the control program of the memory, the processing circuit 23 controls the display of the display unit of the user interface 21, and outputs information on the operation result of the operation unit by the delivery person to the communication device 22.

### Delivery Management System

The delivery management system 50 manages a plurality of delivery vehicles 10. The delivery management system 50 includes a communication device 51, a database 52, and a processing circuit 53.

The communication device 51 is an interface of the delivery management system 50 for transmitting and receiving information to and from an external communication device via the communication network 100. For example, the communication device 51 outputs the information received via the communication network 100 to the processing circuit 53. Further, for example, the communication device 51 transmits the information outputted by the processing circuit 53 to the terminal device 30 of the resident of the delivery destination DD or the portable terminal 20 of the deliverer via the communication network 100.

An example of the processing circuit 53 is an electronic control unit. The processing circuit 53 includes a CPU 54 and a memory 55. The memory 55 stores a control program executed by CPU 54. When CPU 54 executes the control program of the memory 55, the processing circuit 53 executes a series of processing for managing the delivery of the package by the plurality of delivery vehicles 10. The specific contents of this series of processing will be described later.

Various types of information regarding a plurality of delivery destination DD are registered in the database 52. In the present embodiment, the database 52 corresponds to a “storage device”. When the delivery management system 50 manages delivery of packages by the plurality of delivery vehicles 10, the processing circuit 53 utilizes the database 52.

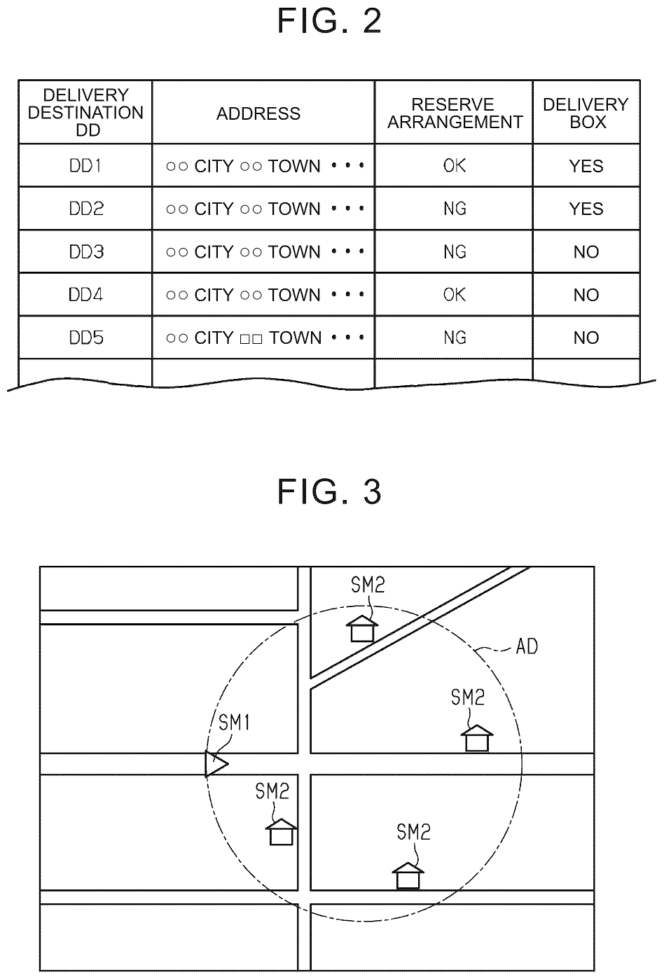

An example of the database 52 will be described with reference to FIG. 2. In the database 52, a plurality of delivery destinations DD1, DD2, DD3, DD4, DD5, . . . , is registered as delivery destination DD. In the database 52, information on the address of the delivery destination, whether or not the placement is permitted, and information on whether or not the delivery box is installed are registered for each DD5 from the delivery destination DD1. The delivery box is a box that can store a package. The home delivery box is installed, for example, at an entrance.

According to the database 52 illustrated in FIG. 2, the delivery destination DD1 is a delivery destination in which the delivery is permitted and the home delivery box is installed. In addition, the delivery destination DD2 is a delivery destination in which the delivery is not permitted and the delivery box is installed. In this case, the phrase “not permitted to place” indicates that it is not clear whether or not to place it instead of prohibiting it.

### Process Flow for Managing Delivery Vehicles

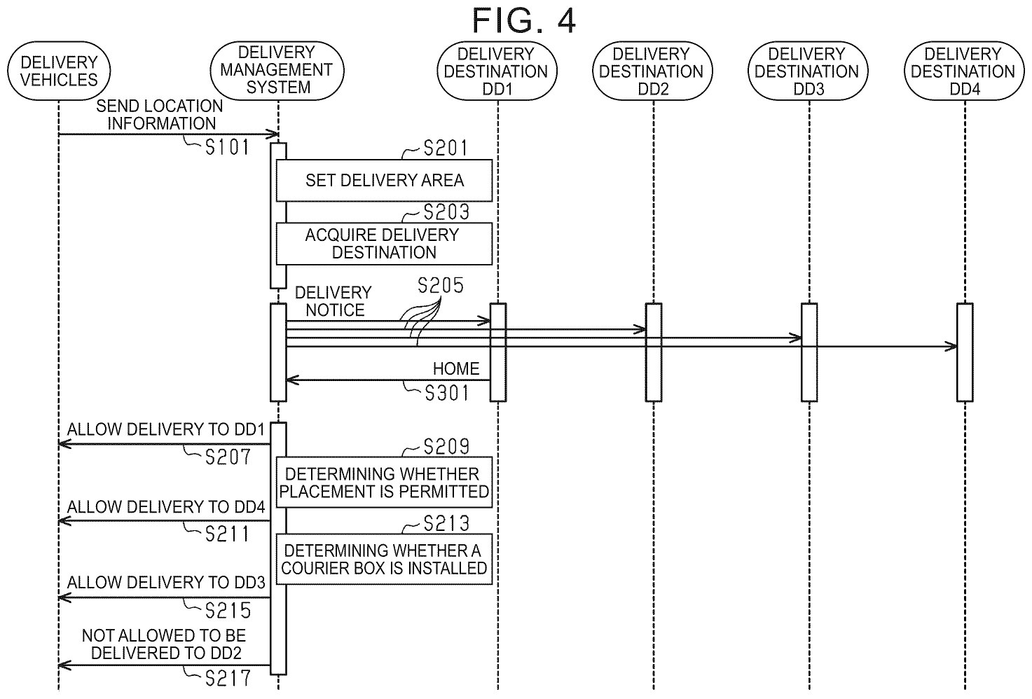

Referring to FIGS. 3 and 4, a flow of processing for managing delivery by the delivery vehicle 10 will be described. FIG. 4 is a sequence diagram illustrating an example of the flow of the processing. In this sequence diagram, a plurality of processes executed by the delivery management system 50 correspond to a series of processes for managing delivery of a package by the plurality of delivery vehicles 10.

As shown in FIG. 4, in S101, the delivery vehicle 10 transmits its location to the delivery management system 50. Thereby, the current position of the delivery vehicle 10 is grasped by the delivery management system 50.

Then, in S201, the processing circuit 53 of the delivery management system 50 sets the delivery area AD based on the present position of the delivery vehicle 10. For example, the processing circuit 53 sets, as the delivery area AD, an area in which the delivery vehicle 10 can deliver the package in a predetermined period from the current time.

FIG. 3 illustrates an exemplary delivery area AD. For example, the processing circuit 53 sets the delivery area AD to include the present position of the delivery vehicle 10. The thumbnail SM1 on the map shown in FIG. 3 indicates the delivery vehicle 10. The thumbnail SM2 indicates a delivery destination DD.

Returning to FIG. 4, when the delivery area AD is set, the processing circuit 53 shifts the processing to S203. In S203, the processing circuit 53 acquires the delivery destination DD included in the delivery area AD based on the information registered in the database 52. In the exemplary embodiments illustrated in FIGS. 3 and 4, the processing circuit 53 acquires four delivery destination DD1, DD2, DD3, DD4.

In the following S205, the processing circuit 53 notifies the plurality of delivery destinations DD1 to DD4 of the delivery of the package. This notification is referred to as “delivery notification”. That is, the processing circuit 53 causes the communication device 51 to transmit a delivery notification to the delivery destination DD located in the delivery area AD. Then, the processing circuit 53 waits for a response to the delivery notification.

In the exemplary embodiment illustrated in FIG. 4, the delivery destination DD1 of the four delivery destinations DD1 to DD4 transmits an answer to the delivery notification to the delivery management system 50 (S301). The resident of the delivery destination DD1 transmits the fact that he/she is at home to the delivery management system 50 as a response to the delivery notification using his/her terminal device 30. On the other hand, from the remaining three delivery destinations DD2 to DD4 does not respond to the delivery notification to the delivery management system 50.

Then, in S207, the processing circuit 53 transmits, to the delivery vehicle 10, information indicating that the delivery of the package to the delivery destination DD1 is permitted. Specifically, the processing circuit 53 causes the information to be transmitted from the communication device 51 to the portable terminal 20 of the deliverer. That is, S207 process corresponds to a process of allowing the delivery vehicle 10 to deliver the package to the delivery destination DD that has received the response to the delivery notification.

Subsequently, in S209, the processing circuit 53 determines whether or not the delivery destination DD is a delivery destination permitted to be placed based on the data registered in the database 52. In the present embodiment, the processing circuit 53 determines whether or not the delivery destinations DD2 to DD4 that have not received a response to the delivery notification are delivery destinations permitted for delivery. According to the database 52, as shown in FIG. 2, only the delivery destination DD4 from the plurality of delivery destinations DD2 to DD4 permits delivery. In other words, the processing circuit 53 determines that the delivery destination DD4 is a delivery destination permitted for delivery. On the other hand, the processing circuit 53 determines that the plurality of delivery destination DD2, DD3 are delivery destinations that are not permitted to be delivered.

In the following S211, the processing circuit 53 transmits, to the delivery vehicle 10, information indicating that the delivery of the package to the delivery destination DD4 is permitted. Specifically, the processing circuit 53 causes the information to be transmitted from the communication device 51 to the mobile terminal 20 of the deliverer. That is, S211 process corresponds to the process of allowing the delivery vehicle 10 to deliver the package even if the delivery destination DD4 determined to be permitted to be placed does not have a response to the delivery notification.

Subsequently, in S213, the processing circuit 53 determines whether or not the delivery box is installed in the delivery destination DD based on the information registered in the database 52. In the present embodiment, the processing circuit 53 determines whether or not a delivery box is installed in a plurality of delivery destination DD2, DD3 that have not received a response to the delivery notification. According to the database 52, as shown in FIG. 2, in the plurality of delivery destination DD2, DD3, a home delivery box is installed only in the delivery destination DD3. That is, the processing circuit 53 determines that the delivery destination DD3 is a delivery destination in which the home delivery device is installed. On the other hand, the processing circuit 53 determines that the delivery destination DD2 is a delivery destination in which no home-delivery-box is installed.

In the following S215, the processing circuit 53 transmits, to the delivery vehicle 10, information indicating that the delivery of the package to the delivery destination DD3 is permitted. Specifically, the processing circuit 53 causes the information to be transmitted from the communication device 51 to the mobile terminal 20 of the deliverer. That is, the process of S213 corresponds to the process of allowing the delivery vehicle 10 to deliver the package even if the delivery destination DD3 determined that the delivery box is installed does not respond to the delivery notification.

Here, in the embodiment illustrated in FIG. 4, the reply to the delivery notification does not arrive at the delivery management system 50 from the delivery destination DD2. The delivery destination DD2 is a delivery destination that is not permitted to be delivered. In addition, the delivery destination DD2 is not provided with a courier.

Therefore, in S217, the processing circuit 53 transmits, to the delivery vehicle 10, information indicating that the delivery of the package to the delivery destination DD2 is not permitted. Specifically, the processing circuit 53 causes the information to be transmitted from the communication device 51 to the mobile terminal 20 of the deliverer. That is, S217 process corresponds to a process of not allowing the delivery vehicle 10 to deliver the package to the delivery destination DD2 that has not received a response to the delivery notification.

### Aggregation Process

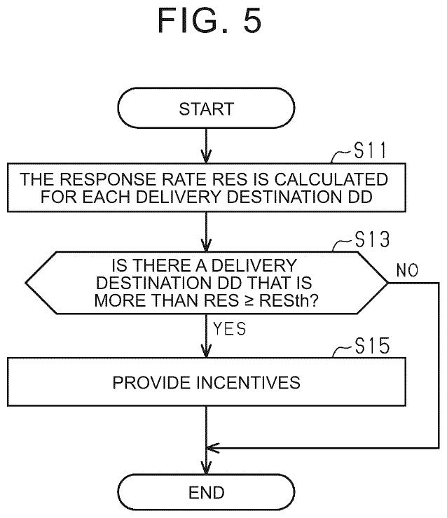

With reference to FIG. 5, an aggregation process executed by the processing circuit 53 of the delivery management system 50 will be described. For example, the processing circuit 53 executes the aggregation processing after the delivery work for a predetermined period is completed. An example of the predetermined period is one month.

In S11, the processing circuit 53 calculates, for each delivery destination S205, a delivery destination DD, a response rate RES that is a chance that an answer to the delivery notification sent to the delivery destination DD has been received. In the following S13, the processing circuit 53 determines whether or not there is a delivery destination DD in which the response rate RES is equal to or greater than the response rate determination value RESth in the plurality of delivery destination DD. When the processing circuit 53 determines that there is a delivery destination DD whose response rate RES is equal to or greater than the response rate determination value RESth (S13:YES), the processing proceeds to S15. On the other hand, when the processing circuit 53 determines that there is no delivery destination DD whose response rate RES is equal to or greater than the response rate determination value RESth (S13:NO), the aggregation processing is ended.

In S15, the processing circuit 53 provides an incentive to the delivery destination DD whose response rate RES is equal to or greater than the response rate determination value RESth. At this time, the processing circuit 53 provides a higher incentive as the delivery destination DD having a higher response rate RES. The incentive is for raising the consciousness of the resident to respond to the delivery notification. For example, the incentive may include a discount on the delivery fee, a discount on the delivery fee, and points available for shopping and the like. Thereafter, the processing circuit 53 ends the aggregation processing.

### Operation and Effect of This Embodiment

(1) When the processing circuit 53 of the delivery management system 50 acquires the position information of the delivery vehicle 10, the processing circuit 53 sets the delivery area AD of the delivery vehicle 10 based on the present position of the delivery vehicle 10. Further, the processing circuit 53 acquires the delivery destination DD located in the delivery area AD. For example, it is assumed that the processing circuit 53 acquires a plurality of delivery destinations DD1 to DD4 as delivery destination DD located in the delivery area AD. Then, the processing circuit 53 transmits a delivery notification from the plurality of delivery destinations DD1 to DD4.

For example, the residents of the delivery destination DD1 from the plurality of delivery destinations DD1 to DD4 use their own terminal devices 30 to transmit the fact that they are at home as a response to the delivery notification to the delivery management system 50. The processing circuit 53 of the delivery management system 50 permits the delivery vehicle 10 to deliver the package to the delivery destination DD1 that has received the response to the delivery notification. Then, the mobile terminal 20 owned by the delivery person of the delivery vehicle 10 is transmitted from the delivery management system 50 to the delivery destination DD1. Here, the delivery vehicle 10 delivers the package to the delivery destination DD1 in which the resident is at home. As a result, when the delivery vehicle 10 arrives at the delivery destination, it is unlikely that the vehicle is absent. Therefore, the delivery management system 50 can reduce the possibility of re-delivery to the delivery destination DD, thereby reducing the burden on the deliverer.
(2) The processing circuit 53 of the delivery management system 50 determines whether or not the delivery destination DD is a delivery destination permitted to be delivered based on the information registered in the database 52. It is assumed that the delivery destination DD4 is a delivery destination to which delivery is permitted. The processing circuit 53 of the delivery management system 50 permits the delivery vehicle 10 to deliver the package even if there is no response to the delivery notification for the delivery destination DD4 determined to be permitted to be placed. Then, the mobile terminal 20 owned by the delivery person of the delivery vehicle 10 is transmitted from the delivery management system 50 to the delivery destination DD4. Therefore, the delivery vehicle 10 delivers the package to the delivery destination DD4 that is permitted to be placed. In this situation, even if the delivery destination DD4 is absent, the deliverer can complete delivery to the delivery destination DD4. Therefore, the delivery management system 50 can reduce the possibility of re-delivery to the delivery destination.
(3) The processing circuit 53 of the delivery management system 50 determines whether or not a home delivery box is installed in the delivery destination DD based on the information registered in the database 52. Assume that the delivery destination DD3 is a delivery destination where a courier is installed. The processing circuit 53 of the delivery management system 50 permits the delivery vehicle 10 to deliver the package even if there is no response to the delivery notification for the delivery destination DD3 determined to have the delivery box installed. Then, the mobile terminal 20 owned by the delivery person of the delivery vehicle 10 is transmitted from the delivery management system 50 to the delivery destination DD3. Therefore, the delivery vehicle 10 delivers the package to the delivery destination DD3. Even if the delivery destination DD3 is absent, the delivery person can complete the delivery to the delivery destination DD3 by storing the package in the delivery destination DD3. Therefore, the delivery management system 50 can reduce the possibility of re-delivery to the delivery destination.
(4) As for the delivery destination DD2, there is no answer to the delivery notification, and the delivery is not permitted, and further, no courier box is installed. In this situation, the processing circuit 53 of the delivery management system 50 does not allow the delivery vehicle 10 to deliver the package to the delivery destination DD2 that has not received a response to the delivery notification. Then, the mobile terminal 20 owned by the delivery person of the delivery vehicle 10 is transmitted from the delivery management system 50 to the effect that delivery to the delivery destination DD2 is not permitted. Therefore, the delivery vehicle 10 may not be directed to the delivery destination DD2. That is, when there is a possibility that the delivery of the package cannot be completed even if the delivery vehicle 10 faces the delivery destination DD2, it is possible to save the time and effort for the delivery vehicle 10 to face the delivery destination DD2. As a result, the delivery management system 50 can suppress an increase in the burden on the delivery person.
(5) In the delivery management system 50, a response rate RES is calculated for each delivery destination DD. Then, an incentive corresponding to the response rate RES is given to the resident of the delivery destination DD. As a result, the delivery management system 50 can improve the consciousness of the resident who responds to the delivery notification.

### Modifications

The above-described embodiment can be modified as follows. The above-described embodiments and the following modifications can be implemented in combination with each other as long as they are not technically contradictory.
The delivery management system 50 may provide an incentive to the resident of the delivery destination DD who has replied the reply to the delivery notification, while not providing an incentive to the resident of the delivery destination DD who has not replied the reply to the delivery notification.
It is not essential to incentivize the inhabitants of the destination DD.
It is not necessary to register, in the database 52, information regarding whether or not a home delivery box is installed in the delivery destination DD. In this case, the delivery management system 50 does not need to determine whether or not to permit the delivery of the package to the delivery vehicle 10 based on the presence or absence of the home delivery box with respect to the delivery destination DD that has not received a response to the delivery notification.
The database 52 does not need to register information regarding whether or not placement is permitted. In this case, the delivery management system 50 does not need to determine whether or not the delivery of the package is permitted to the delivery vehicle 10 depending on whether or not the delivery of the package is permitted for the delivery destination DD that has not received a response to the delivery notification.
The processing circuit 53 of the delivery management system 50 may set the delivery area AD by a method other than the method described in the above embodiment. For example, when the present position of the delivery vehicle 10 is “○○ town”, the processing circuit 53 may set “○○ town” as the delivery area AD. Further, the processing circuit 53 may set an area including either “○○ town” or a town adjoining “○○ town” as the delivery area AD.
If the delivery area AD is set based on the current position of the delivery vehicle 10, the processing circuit 53 may set the delivery area AD so as not to include the current position of the delivery vehicle 10. For example, when the present position of the delivery vehicle 10 is “○○ town”, the processing circuit 53 may set an area that includes another area adjacent to “○○ town” but does not include “○○ town” as the delivery area AD.
The control device mounted on the delivery vehicle 10 may function as the delivery management system 50. In this case, the processing circuit includes a processing circuit and a database. Information on a plurality of delivery destinations delivered by the delivery vehicle 10 is registered in the database. When the delivery area AD is set based on the present position of the delivery vehicle 10, the processing circuit transmits a delivery notification to the delivery destination DD included in the delivery area AD. For example, the processing circuit may cause the delivery notification to be transmitted to the delivery destination DD from the mobile terminal 20 owned by the delivery person who gets on the delivery vehicle 10.
The processing circuitry of the delivery management system includes a CPU and a ROM, and is not limited to executing software processing. That is, the processing circuit may have any of the following configurations (a), (b) and (c).
(a) The processing circuit includes one or more processing circuits that execute various kinds of processing in accordance with a computer program. The processing circuit includes CPU and memories such as RAM and ROM. The memory stores program code or instructions configured to cause CPU to execute the process. Memory, or computer readable media, includes any available media that can be accessed by a general purpose or special purpose computer.
(b) The processing circuit includes one or more dedicated hardware circuits for executing various processes. Dedicated hardware circuits may include, for example, application-specific integrated circuits, i.e., ASIC or FPGA. Note that ASIC is an abbreviation of “Application Specific Integrated Circuit”, and FPGA is an abbreviation of “Field Programmable Gate Array”.
(c) The processing circuit includes a processing circuit that executes a part of various kinds of processing in accordance with a computer program, and a dedicated hardware circuit that executes the remaining kinds of processing among the various kinds of processing.

What is claimed is:

1. A delivery management system that manages a delivery vehicle that delivers a package, the delivery management system comprising a processing circuit configured to:
set a delivery area in which the delivery vehicle delivers the package based on a current position of the delivery vehicle;
notify a delivery destination of the package located in the delivery area that the package is to be delivered;
allow the delivery vehicle to deliver the package to the delivery destination that has responded to the notification that the package is to be delivered; and
not permit the delivery vehicle to deliver the package to the delivery destination that has not responded to the notification.

2. The delivery management system according to claim 1, further comprising a storage device in which information as to whether delivery by leaving a package is permitted is registered for each delivery destination, wherein:
the processing circuit is configured to determine whether the delivery destination permits delivery by leaving a package based on the information registered in the storage device; and
the processing circuit is configured to permit the delivery vehicle to deliver the package for the delivery destination determined to permit delivery by leaving a package, even if the delivery destination has not responded to the notification.

3. The delivery management system according to claim 1, further comprising a storage device in which information as to whether a delivery box capable of accommodating a package is installed is registered for each delivery destination, wherein:
the processing circuit is configured to determine whether the delivery box is installed at the delivery destination based on the information registered in the storage device; and
the processing circuit is configured to permit the delivery vehicle to deliver the package for the delivery destination for which it is determined that the delivery box is installed, even if the delivery destination has not responded to the notification.

4. The delivery management system according to claim 1, wherein:
the processing circuit is configured to summarize a response rate for each delivery destination, the response rate being a probability of responding to the notification; and
the processing circuit is configured to assign a higher incentive to a delivery destination with a higher response rate than a delivery destination with a lower response rate.
